(19) United States
(12) Patent Application Publication
(10) Pub. No.: US 2017/0172110 A1
(43) Pub. Date: Jun. 22, 2017

(54) PET RESTRAINT

(71) Applicant: ANIMAGANZA, LLC, Everett, WA (US)

(72) Inventor: ALAN J. DEWEY, Everett, WA (US)

(21) Appl. No.: 15/388,714

(22) Filed: Dec. 22, 2016

Related U.S. Application Data
(60) Provisional application No. 62/270,769, filed on Dec. 22, 2015.

(51) Int. Cl. A01K 27/00

(52) U.S. Cl. CPC A01K 27/002; A01K 27/003; A01K 27/001

(57) ABSTRACT

A pet restraint is disclosed. The pet restraint may include a clasp, a collar attachment strap, a chest strap, and a leash. The clasp may releasably attach to the front (underside) of the pet's collar. The collar attachment strap may be affixed to the clasp, and the collar attachment strap may extend downward, through the pet's front legs, to the bottom of the chest strap. The chest strap may extend around the pet's chest. The leash may attach to the chest strap over the pet's spine, and the leash may extend upward to the hand of the pet owner.

### CROSS-REFERENCE TO RELATED APPLICATIONS

This is a nonprovisional claiming priority under 35 U.S.C. §119 of co-pending U.S. Provisional Patent Application No. 62/270,769, entitled “HARNELEASH PET RESTRAINT”, filed on Dec. 22, 2015. The prior application is incorporated by reference herein in its entirety.

### BACKGROUND

Traditionally, dog, cat, and other pet owners have attached leashes to pet collars in order to restrain their pets during walks. Leashes attach to the back of pet collars, so when pets pull on leashes, their collars pull against their throats. Traditional leash and collar arrangements therefore choke pets while also risking or causing neck injury.

Because of this, pet owners have been adopting harnesses, which strap around pets' shoulders and chests and attach to traditional leashes to restrain pets during walks. A variety of pet harness products are available. However, some currently available pet harness designs are confusing to pet owners and/or too difficult to put on pets, which can result in non-use of harnesses. There is a need to simplify the pet harness and leash design.

### SUMMARY

A novel pet restraint is disclosed. The pet restraint may generally include simplified equipment to restrain a pet, without applying choking pressure to the pet's neck. In some examples, a pet restraint may include a collar attachment with a front fastener which is releasably attachable to an underside of a pet collar, and a chest strap attached to a rearward end of the collar attachment. The collar attachment may extend from the pet collar through the pet's front legs, then attach to the chest strap under the pet's chest. A chest fastener on the chest strap may releasably fasten the chest strap around the pet's chest. The pet restraint may further include a leash and a top fastener attached to the chest strap and to a forward end of the leash, wherein the top fastener and forward end of the leash are positionable along the chest strap above the pet's spine.

Because the pet restraint attaches to the front underside of the pet's collar, and then travels down through the pet's front legs and around the pet's chest to the back of the pet's shoulders, any stress from the pet (or pet owner) pulling on the leash is distributed around the pet's chest to the front underside of the collar, thereby eliminating choking pressure on the front of the pet's neck or throat. Additional aspects and features of this disclosure will be apparent from the detailed description and drawings.

### BRIEF DESCRIPTION OF THE DRAWINGS

Various features and attendant advantages of the disclosed technologies will become fully appreciated when considered in conjunction with the accompanying drawings, in which like reference characters designate the same or similar parts throughout the several views, and wherein:

FIG. 1 illustrates an example pet restraint fitted on a pet and in use by a pet owner.

FIG. 2 illustrates an example pet restraint configuration.

FIG. 3 illustrates further example pet restraint configurations.

FIG. 4 illustrates further example pet restraint configurations.

FIG. 5 illustrates further example pet restraint configurations.

FIG. 6 illustrates further example pet restraint configurations.

FIG. 7 illustrates an example method of use of a pet restraint.

FIG. 8 illustrates a top view of an example pet restraint.

FIG. 9 illustrates a side view of an example pet restraint.

### DETAILED DESCRIPTION

Prior to explaining embodiments of the invention in detail, it is to be understood that this disclosure is not limited to the details of construction or arrangements of the components and method steps set forth in the following description or illustrated in the drawings. Embodiments of this disclosure are capable of other embodiments and of being practiced and carried out in various ways. Also, it is to be understood that the phraseology and terminology employed herein are for the purpose of the description and should not be regarded as limiting.

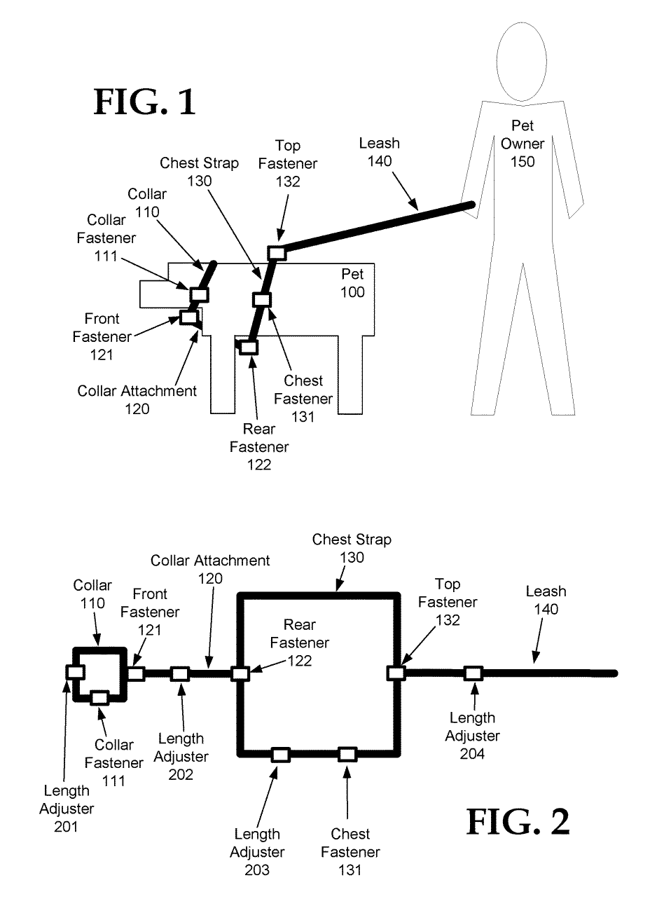

This disclosure describes a novel pet restraint design, and methods for making and/or using the disclosed pet restraint. FIG. 1 illustrates an example pet restraint fitted on a pet 100 and in use by a pet owner 150, in accordance with at least some embodiments of this disclosure. The illustrated pet restraint includes, inter alia, a front fastener 121, a collar attachment 120, a chest strap 130, a chest fastener 131, a top fastener 132, and a leash 140.

In FIG. 1, the front fastener 121 releasably attaches to a collar 110 at the front underside of the collar 110. The collar attachment 120 is affixed to the front fastener 121, and the collar attachment 120 extends through the pet's 100 front legs. The collar attachment 120 attaches to the chest strap 130 underneath the pet's 100 chest. The chest strap 130 extends around the pet's 100 chest. The ends of the chest strap 130 fasten together at chest fastener 131. The top fastener 132 fastens the top of the chest strap 130, at a location generally over the pet's 100 spine, to a forward end of the leash 140. The leash 140 extends from the top fastener 132 to the hand of the pet owner 150.

The collar 100 may, but need not necessarily be included as a part of the pet restraint. Many pets already have a suitable collar to which disclosed pet restraints may attach. The collar 100 may for example be a standard collar type including, for example, a collar strap and collar fastener 111. The collar 100 may include a ring or other attachment point to which the front fastener 121 may be releasably attached.

A variety of additional fasteners and length adjusters may be included in some embodiments. For example, some embodiments may include a rear fastener 122. The rear fastener 122 may adjoin the collar attachment 120 and the chest strap 130. FIG. 2-FIG. 6 furthermore illustrate various example pet restraint configurations including a variety of additional fasteners and length adjusters.

FIG. 2 illustrates an example pet restraint configuration, in accordance with at least some embodiments of this disclosure, wherein like elements are given like identifiers. The illustrated pet restraint includes collar 110, collar fastener 111, and a length adjuster 201. The illustrated pet restraint further includes collar attachment 120, front fastener 121, a length adjuster 202, and rear fastener 122. The illustrated pet restraint further includes chest strap 130, chest fastener 131, top fastener 132, and a length adjuster 203. The illustrated pet restraint further includes leash 140 and a length adjuster 204.

e SEQ PTO \#“[000#]”\*MERGEFORMAT [0022] In FIG. 2, any of collar 110, collar attachment 120, chest strap 130, or leash 140 may comprise a strap. Example straps include, e.g., ¾ inch or 1 inch wide woven mesh straps, woven from a nylon or other strong and flexible material. Example straps may optionally have reflective strips along the edges thereof, or a reflective strip down the middle thereof. Example straps may optionally be waterproof and stain resistant, and may optionally be made from recycled materials.

In alternative embodiments, any of collar 110, collar attachment 120, chest strap 130, or leash 140 may comprise any of a variety of other structures or materials as desired. For example, chain, cord, fabric, leather, rubber, plastic, metal, or other materials may be used to make the collar 110, collar attachment 120, chest strap 130, or leash 140.

In FIG. 2, any of collar 110, collar attachment 120, chest strap 130, or leash 140 may be of adjustable length. FIG. 2 illustrates an adjustable length collar 110 including length adjuster 201 for length adjustment thereof, an adjustable length collar attachment 120 including length adjuster 202 for length adjustment thereof, an adjustable length chest strap 130 including length adjuster 203 for length adjustment thereof, and an adjustable length leash 140 including length adjuster 204 for length adjustment thereof.

Length adjusters 201, 202, 203, and 204 may comprise, e.g., any known length adjustment mechanisms. For example, plastic or metal three-bar type strap length adjustment mechanisms may permit one strap to be sewn a first bar, while another strap threads through the remaining two bars. The length of the strap(s) may be adjusted, e.g., by changing the length of strap which is threaded through the strap length adjuster mechanism. In some embodiments, any of a variety of belt buckle type structures may be used as length adjusters. In some embodiments, Velcro® or snaps may be used as length adjusters. In some embodiments, a band may be included to secure any loose strap ends.

In some embodiments, any of length adjusters 201, 202, 203, or 204 may be combined with adjacent fasteners. For example, length adjuster 201 may be combined with collar fastener 111, length adjuster 202 may be combined with front fastener 121 or rear fastener 122, length adjuster 203 may be combined with chest fastener 131, or length adjuster 204 may be combined with top fastener 132. For example, when a fastener includes a buckle, a buckle element may include a two bar structure allowing a strap to be adjustably threaded there through.

FIG. 2 illustrates a front fastener 121 attached to the collar attachment 120 and positioned at a forward end of the collar attachment 120. The front fastener 121 may comprise, for example, a clasp that is releasably attachable to an underside of the pet collar 110, as shown in FIG. 1. By attaching at the front underside of the collar 110, any pulling pressure from the front fastener 121 on the collar 110 will pull down on the collar 110, rather than up. As a result, the pet restraint does not apply choking pressure on the pet's 100 throat. The front fastener 121 may have any desired design. In some embodiments, the front fastener 121 may comprise a releasable clasp which may be securely attached and detached from the pet collar 110 by hand without any tools. The front fastener 121 may comprise, e.g., a metal clasp with a spring loaded slider mechanism which slides down to open the clasp and returns to a closed position under the force of the spring. The front fastener 121 may include any hook, eye, wedge, ring, spring, door, or other structures as appropriate to attach to a pet collar 110, e.g., by attaching to a metal ring on the pet collar 110 or by attaching to the front underside of the pet collar 110 itself.

In FIG. 2, the illustrated collar attachment 120 may comprise an adjustable length collar attachment strap including a length adjuster 203 for length adjustment thereof. For example, collar attachment 120 may comprise a loop of nylon strap which is threaded through the front fastener 121 at a forward end of collar attachment 120, and threaded through the chest strap 130 at a rearward end of collar attachment 120. In some embodiments, the collar attachment 120 may be “affixed” to the chest strap 130 and front fastener 121 by being looped or threaded into those elements, and the front fastener 121 and chest strap 130 may be slidable along the collar attachment 120. In some embodiments, the collar attachment 120 may be affixed to the chest strap 130 and front fastener 121 by, for example, being sewn, glued, stapled, or otherwise permanently and non-slidably affixed to chest strap 130 and/or front fastener 121. In embodiments comprising a rear fastener 122, the collar attachment 120 may be affixed to the rear fastener 122, and rear fastener 122 may be affixed to chest strap 130.

The collar attachment 120 may be rigid or flexible. The collar attachment 120 may be adjustable length, such as in FIG. 2, or the collar attachment 120 may have a fixed length. Example dimensions for the collar attachment 120 may depend on the intended pet size, and may range from about 6 centimeters for very small pets, to about 50 centimeters for large pets.

Rear fastener 122 may be included in some embodiments. In some embodiments, rear fastener 122 may comprise, e.g., an “o-ring,” such as a ring of metal, rubber, plastic, or other sturdy material. The o-ring may take any shape, such as a circle, square, triangle, or other polygon. In some embodiments, rear fastener 122 may comprise, e.g., a releasable fastener such as a clasp or buckle. In some embodiments, rear fastener 122 may be omitted, and collar attachment 120 may be sewn onto chest strap 130, or collar attachment 120 may be looped around chest strap 130, and the loop may be secured for example at length adjuster 202 or at front fastener 121.

Chest strap 130 may generally comprise a strap which is attached to a rearward end of the collar attachment 120 as well as to top fastener 132, and which releasably fastens around the pet's 100 chest using chest fastener 131. Chest strap 130 may comprise, e.g., a nylon strap or other material, as disclosed herein. Chest strap 130 may attach to collar attachment 120, e.g., by being threaded through rear fastener 122, or otherwise, as described herein. Similarly, chest strap 130 may be sewn to or threaded through top fastener 132.

Chest fastener 131 may be attached to the chest strap 130, and chest fastener 131 may serve to releasably attach the chest strap 130 around the pet's 100 chest. In some embodiments, the chest fastener 131 may comprise a buckle including a first buckle element attached at a first end of the chest strap 130 and a second buckle element attached at a second end of the chest strap 130. The first and second buckle elements may be adapted to releasably buckle together in order to releasably fasten the chest strap 130 around the pet's 100 chest. The length of the chest strap 130 may be adjustable, for example, by adjusting buckle position at the first or second end of the chest strap 130.

In some embodiments wherein chest fastener 131 comprises a buckle, the ends of the chest strap 130 may be respectively affixed to a male and a female member of a releasable buckle. The chest strap 130 may thereby be buckled to form a loop around the pet's 100 chest, and unbuckled to remove the chest strap 130 from the pet 100. In some embodiments, the chest strap 130 may be buckled at one side of the pet's 100 chest, and the buckle need not interfere with the leash 140 attached over the pet's 100 spine. In some embodiments, chest fastener 131 may comprise any of a variety of other fasteners (other than a buckle), such as clasps, snaps, or otherwise.

In some embodiments, the circumference of the chest strap 130 may be adjustable in length. For example, one end of the chest strap 130 may be sewn onto a buckle member (either male or female) of chest fastener 131, while the other end of the chest strap 130 may thread through the other buckle member (either male or female) of chest fastener 131. The other end of the chest strap 130 may return to length adjuster 203. The length of the chest strap 130 may be adjusted, e.g., by changing the length of chest strap 130 which is threaded through the buckle member of chest fastener 131. In some embodiments, a band may be used to secure the loop produced by threading the chest strap 130 through the buckle member of chest fastener 131, to thereby secure such loop in a substantially closed position, e.g., to minimize confusion by keeping the loop closed.

In some embodiments, length adjuster 203 may be combined with chest fastener 131, as described herein, and the circumference of the chest strap 130 may be adjusted by pulling (or releasing a free end of chest strap 130 through a buckle element which is also designed for length adjustment. In some embodiments, the chest strap 130 may have multiple snaps affixed thereto, to allow adjustment of the circumference of the chest strap 130. In some embodiments, the chest strap 130 may have a fixed length. Example dimensions for the chest strap 130 may depend on the intended pet size, and may range from about 30 centimeters for very small pets, to about 200 centimeters for large pets.

Top fastener 132 may be attached to the chest strap 130 and to a forward end of the leash 140. In some embodiments, top fastener 132 be non-releasably attached to the chest strap 130 and to the forward end of the leash 140. For example, the top fastener 132 may comprise an o-ring, such as a circular or rectangular ring of hard plastic or metal. The chest strap 130 may be threaded through the o-ring top fastener 132, and the leash 140 may also be threaded through the o-ring top fastener 132. The leash 140 may be doubled back and sewn together to form a non-releasable attachment between leash 140 and top fastener 132. The o-ring top fastener 132 may be slidable along the chest strap 130, so that the top fastener 132 and forward end of the leash 140 are repositionable above the pet's 100 spine, and retain some freedom of motion along the chest strap 130. Alternatively, the top fastener 132 may be sewn in a fixed position on chest strap 130, opposite a point where collar attachment 120 attaches to chest strap 130.

Top fastener 132 may be omitted in some embodiments, e.g., by threading the leash 140 around the chest strap 130. Furthermore, in some embodiments, top fastener 132 may comprise other fastener structures, optionally including releasable fastener structures, such as buckles, ties, buttons, snaps, clasps, and the like.

The leash 140 may be affixed, at a forward end of leash 140, to the chest strap 130. The leash 140 may optionally attach to chest strap 130 via top fastener 132. The leash 140 may releasably or non-releasably attach to top fastener 132. The leash 140 may be adjustable length in some embodiments, e.g., through the use of a length adjuster 204, or the leash may have a fixed length. The leash 140 may comprise a retractable leash in some embodiments. In some embodiments, the leash 140 may comprise a loop or other handle structure at a handle end (rearward end) opposite the forward end. For example, an end of the leash 140 may be looped back and sewn, glued, or otherwise attached along a length of the leash 140 to form a leash handle. Example length dimensions for the leash 140 may range from about 100 centimeters to about 300 centimeters, depending on desired length.

Some advantages of arrangements such as illustrated in FIG. 1 are: simplicity, low bulk, no need to remove pet's collar 110, easy to hang on a hook along with ordinary leashes, absence of a direct connection between the leash 140 and the collar 110 thereby preventing choking pressure on the pet's 100 throat, the ability to attach to the front underside of the collar 110, thereby eliminating any need to turn the collar 110 “upside down”, and the collar attachment 120 prevents the chest strap 130 from sliding backward across the pet's 100 chest. The disclosed pet restraint may therefore be superior to designs which attach to the back (topside) of the pet's collar 110, which still cause a choking pressure on the pet's 100 throat when a pet 100 or pet owner 150 pulls. The pet restraint may also be superior to designs which strap around a pet's 100 waist and the back (topside) of a pet's collar 110, which not only choke the pet 100 but also apply pressure on the pet's 100 bladder.

In some embodiments, pet restraints may omit and/or combine various elements illustrated in FIG. 1. For example, the collar 110 may be omitted in some embodiments, as noted above. Some embodiments may omit the leash 140, while instead allowing pet owners to releasably attach their own leash at top fastener 132. Some embodiments may omit the rear fastener 122, e.g., when collar attachment 120 is configured as a loop which loops through front fastener 121 and around chest strap 130, or when collar attachment 120 is sewn to chest strap 130. Some embodiments may omit one or more of the length adjusters 202, 203, or 204, and may instead use a fixed length collar attachment 120, chest strap 130, or leash 140. Some embodiments may combine length adjusters and fasteners, for example by combining chest fastener 131 and length adjuster 203, combining front fastener 121 and length adjuster 202, or combining top fastener 132 and length adjuster 204. FIG. 2-FIG. 6 illustrate example pet restraint configurations which include limited subsets of the elements illustrated in FIG. 2.

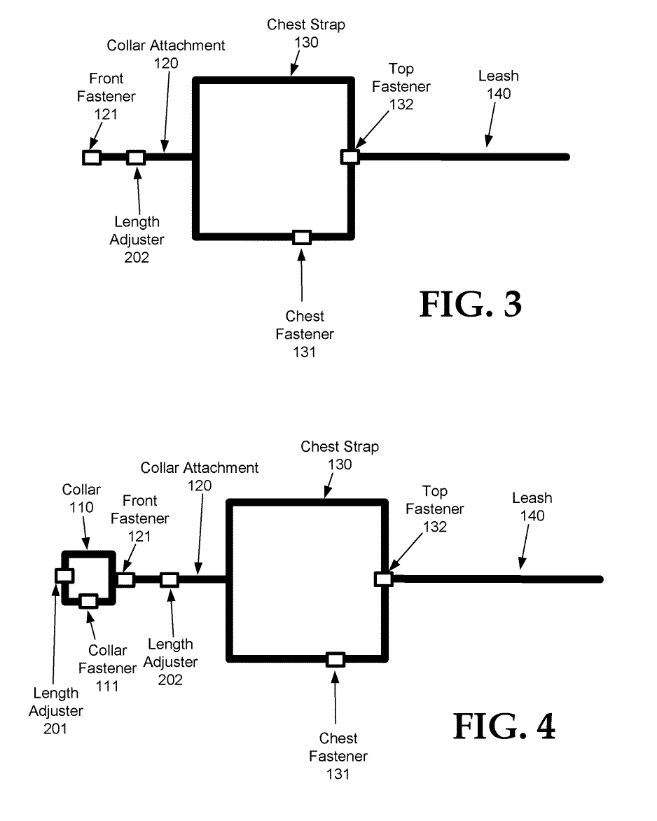

FIG. 3 illustrates further example pet restraint configurations, in accordance with at least some embodiments of the present disclosure. In one example configuration, FIG. 3 illustrates a pet restraint consisting of: an adjustable length collar attachment strap 120 including a length adjuster 202 for length adjustment thereof; a front fastener 121 attached to the collar attachment strap 120 and positioned at a forward end of the collar attachment strap 120, wherein the front fastener 121 may comprise for example, a clasp that is releasably attachable to an underside of a pet collar; an adjustable length chest strap 130 attached to the collar attachment strap 120 and positioned at a rearward end of the collar attachment strap 120; a chest fastener 131 attached to the chest strap 130, wherein the chest fastener 131 may comprise, for example, a buckle including a first buckle element attached at a first end of the chest strap 130 and a second buckle element attached at a second end of the chest strap 130, and wherein the first and second buckle elements are adapted to releasably buckle together in order to releasably fasten the chest strap 130 around the pet's 100 chest, and wherein length of the chest strap 130 is adjustable by adjusting buckle position at the first or second end of the chest strap 130; a leash 140; and a top fastener 132 attached to the chest strap 130 and to a forward end of the leash 140, wherein the top fastener 132 may be, for example, slidably attached to the chest strap 130 so that the top fastener 132 and forward end of the leash 140 are positionable above the pet's 100 spine. In FIG. 3, the top fastener 132 may be releasably or non-releasably attached to the chest strap 130 and to the forward end of the leash 140, as described herein. The top fastener 132 may comprise, e.g., a rectangular loop of metal, as described herein.

In another example configuration, FIG. 3 illustrates a pet restraint comprising three straps and a plurality of fasteners. The three straps consist of: a collar attachment strap 120; a chest strap 130 attached to the collar attachment strap 120 and positioned at a rearward end of the collar attachment strap 120; and a leash. The plurality of fasteners may comprise: a front fastener 121 attached to the collar attachment 120 and positioned at a forward end of the collar attachment 120, wherein the front fastener 121 is releasably attachable to an underside of a pet collar; a chest fastener 131 attached to the chest strap 130, wherein the chest fastener 131 may comprise, e.g., a first fastener element attached at a first end of the chest strap 130 and a second fastener element attached at a second end of the chest strap 130, and wherein the first and second fastener elements are adapted to releasably fasten together in order to releasably fasten the chest strap 130 around the pet's 100 chest; and a top fastener 132 attached to the chest strap 130 and to a forward end of the leash 140, wherein the top fastener 132 and forward end of the leash 140 are positionable above the pet's 100 spine. Further fasteners and/or length adjusters may be included in some embodiments, as described herein.

FIG. 4 illustrates further example pet restraint configurations, in accordance with at least some embodiments of the present disclosure. In one example configuration, FIG. 4 illustrates a pet restraint consisting of: an adjustable length collar 110 including a length adjuster 201 for length adjustment thereof; a collar fastener 111 attached to the collar 110, wherein the collar fastener 111 may comprise, for example, a buckle; an adjustable length collar attachment strap 120 including a length adjuster 202 for length adjustment thereof; a front fastener 121 attached to the collar attachment strap 120 and positioned at a forward end of the collar attachment strap 120, wherein the front fastener 121 may comprise for example, a clasp that is releasably attachable to an underside of a pet collar; an adjustable length chest strap 130 attached to the collar attachment strap 120 and positioned at a rearward end of the collar attachment strap 120; a chest fastener 131 attached to the chest strap 130, wherein the chest fastener 131 may comprise, for example, a buckle including a first buckle element attached at a first end of the chest strap 130 and a second buckle element attached at a second end of the chest strap 130, and wherein the first and second buckle elements are adapted to releasably buckle together in order to releasably fasten the chest strap 130 around the pet's 100 chest, and wherein length of the chest strap 130 is adjustable by adjusting buckle position at the first or second end of the chest strap 130; a leash 140; and a top fastener 132 attached to the chest strap 130 and to a forward end of the leash 140, wherein the top fastener 132 may be, for example, slidably attached to the chest strap 130 so that the top fastener 132 and forward end of the leash 140 are positionable above the pet's 100 spine.

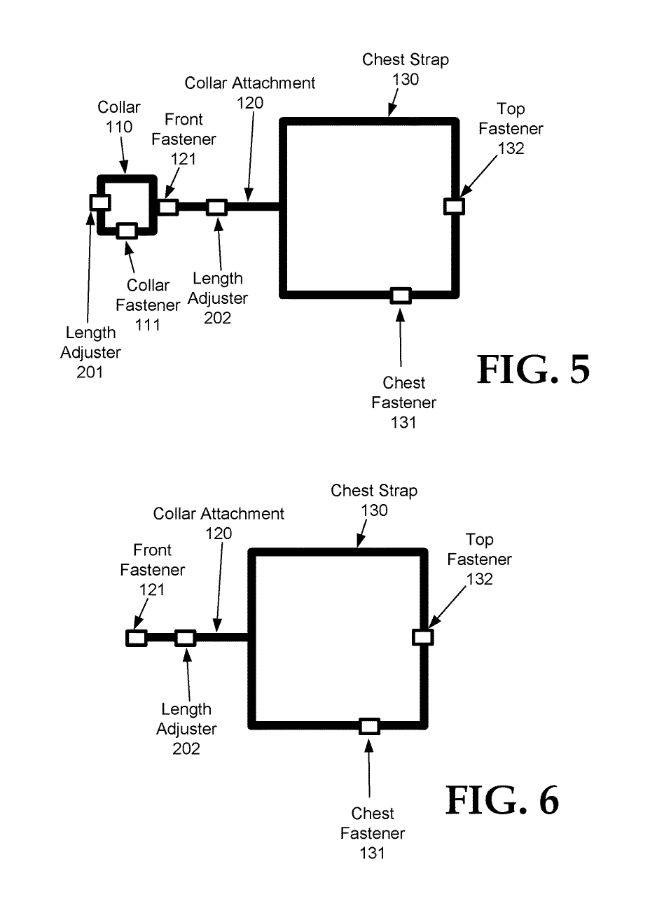

FIG. 5 illustrates further example pet restraint configurations, in accordance with at least some embodiments of the present disclosure. In one example configuration, FIG. 5 illustrates a pet restraint consisting of: an adjustable length collar 110 including a length adjuster 201 for length adjustment thereof; a collar fastener 111 attached to the collar 110, wherein the collar fastener 111 may comprise, for example, a buckle; an adjustable length collar attachment strap 120 including a length adjuster 202 for length adjustment thereof; a front fastener 121 attached to the collar attachment strap 120 and positioned at a forward end of the collar attachment strap 120, wherein the front fastener 121 may comprise for example, a clasp that is releasably attachable to an underside of a pet collar; an adjustable length chest strap 130 attached to the collar attachment strap 120 and positioned at a rearward end of the collar attachment strap 120; a chest fastener 131 attached to the chest strap 130, wherein the chest fastener 131 may comprise, for example, a buckle including a first buckle element attached at a first end of the chest strap 130 and a second buckle element attached at a second end of the chest strap 130, and wherein the first and second buckle elements are adapted to releasably buckle together in order to releasably fasten the chest strap 130 around the pet's 100 chest, and wherein length of the chest strap 130 is adjustable by adjusting buckle position at the first or second end of the chest strap 130; and a top fastener 132 attached to the chest strap 130 and attachable to a forward end of a leash, wherein the top fastener 132 may be, for example, slidably attached to the chest strap 130 so that the top fastener 132 and a forward end of a leash are positionable above the pet's 100 spine.

FIG. 6 illustrates further example pet restraint configurations, in accordance with at least some embodiments of the present disclosure. In one example configuration, FIG. 6 illustrates a pet restraint consisting of: an adjustable length collar attachment strap 120 including a length adjuster 202 for length adjustment thereof; a front fastener 121 attached to the collar attachment strap 120 and positioned at a forward end of the collar attachment strap 120, wherein the front fastener 121 may comprise for example, a clasp that is releasably attachable to an underside of a pet collar; an adjustable length chest strap 130 attached to the collar attachment strap 120 and positioned at a rearward end of the collar attachment strap 120; a chest fastener 131 attached to the chest strap 130, wherein the chest fastener 131 may comprise, for example, a buckle including a first buckle element attached at a first end of the chest strap 130 and a second buckle element attached at a second end of the chest strap 130, and wherein the first and second buckle elements are adapted to releasably buckle together in order to releasably fasten the chest strap 130 around the pet's 100 chest, and wherein length of the chest strap 130 is adjustable by adjusting buckle position at the first or second end of the chest strap 130; and a top fastener 132 attached to the chest strap 130 and attachable to a forward end of a leash, wherein the top fastener 132 may be, for example, slidably attached to the chest strap 130 so that the top fastener 132 and a forward end of a leash are positionable above the pet's 100 spine.

In some embodiments, a pet restraint according to this disclosure may consist of a clasp front fastener 121 which attaches to a pet collar 110, at the front underside of the collar 110, an adjustable length collar attachment strap 120 affixed to the clasp front fastener 121, an adjustable circumference chest strap 130 affixed to the collar attachment strap 120, a releasable buckle chest fastener 131 on the chest strap 130, length adjusters 202, 203 on the chest strap 130 and collar attachment strap 120, and a leash 140 affixed to the chest strap 130 via an o-ring top fastener 132.

In some embodiments, a pet restraint according to this disclosure may consist of a clasp front fastener 121 which attaches to a pet collar 110, at the front underside of the collar 110, an adjustable length collar attachment strap 120 affixed to the clasp front fastener 121, an adjustable circumference chest strap 130 affixed to the collar attachment strap 120, a releasable buckle chest fastener 131 on the chest strap 130, length adjusters 202, 203 on the chest strap 130 and collar attachment strap 120, bands to secure loops in the chest strap 130 and collar attachment strap 120, and a leash 140 affixed to the chest strap 130 via an o-ring top fastener 132.

In some embodiments, pet restraint according to this disclosure may consist of a clasp front fastener 121 which attaches to a pet collar 110, at the front underside of the collar 110, an adjustable length collar attachment strap 120 affixed to the clasp front fastener 121, an adjustable circumference chest strap 130 affixed to the collar attachment strap 120, a releasable buckle chest fastener 131 on the chest strap 130, length adjusters 202, 203 on the chest strap 130 and collar attachment strap 120, a leash 140 affixed to the chest strap 130, and o-rings to affix one or more of the collar attachment strap 120 and the clasp front fastener 121, the collar attachment strap 120 and the chest strap 130, or the chest strap 130 and the leash 140.

In some embodiments, a pet restraint according to this disclosure may consist of a clasp front fastener 121 which attaches to a pet collar 110, at the front underside of the collar 110, an adjustable length collar attachment strap 120 affixed to the clasp front fastener 121, an adjustable circumference chest strap 130 affixed to the collar attachment strap 120, a releasable buckle chest fastener 131 on the chest strap 130, length adjusters 202, 203 on the chest strap 130 and collar attachment strap 120, and a leash 140 affixed to the chest strap 130.

In some embodiments, a pet restraint according to this disclosure may consist of a clasp front fastener 121 which attaches to a pet collar 110, at the front underside of the collar 110, a collar attachment strap 120 affixed to the clasp front fastener 121, a chest strap 130 affixed to the collar attachment strap 120, a releasable buckle chest fastener 131 on the chest strap 130, a leash 140 affixed to the chest strap 130, and o-rings to affix one or more of the collar attachment strap 120 and the clasp front fastener 121, the collar attachment strap 120 and the chest strap 130, or the chest strap 130 and the leash 140.

In still further pet restraint embodiments, chest strap 130 and leash 140 may be combined into a combined leash and chest strap. An example combined leash and chest strap may comprise a strap with an o-ring sewn at a forward end thereof, and a leash handle at a rearward end thereof. The leash handle may be threaded through rear fastener 122, and the leash handle may be brought around one side of the pet's 100 chest, while the o-ring sewn at the forward end may be brought around an opposite side of the pet's 100 chest. The leash handle may then be threaded through the o-ring sewn at the forward end, and the combined leash and chest strap may tighten around the pet's 100 chest as the leash handle is pulled up and away from the pet 100.

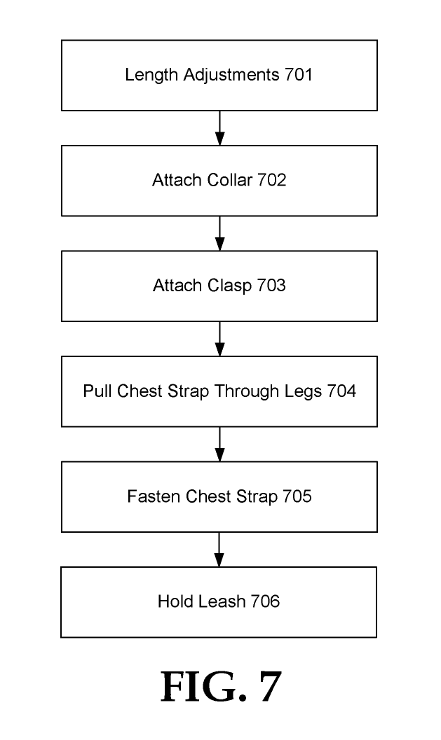

FIG. 7 illustrates an example method of use of a pet restraint, in accordance with at least some embodiments of the present disclosure. In a length adjustments step 701, the length of the collar 110, collar attachment 120, and/or the circumference of the chest strap 130 may be adjusted to fit the size of the pet 100. In an attach collar step 702, the collar 110 may be attached around the pet's 100 neck. In an attach clasp step 703, the clasp 121 may be attached to the pet collar 110, e.g., at an underside of collar 110. In a pull chest strap through legs step 704, the collar attachment strap 120 and chest strap 130 may be pulled between the pet's 100 front legs. In a fasten chest strap step 705, the chest strap 130 may be buckled or otherwise fastened around the pet's 100 chest. In a hold leash 706, the leash 140 may be taken into the hand of the pet owner, and the pet 100 is then securely restrained, with the leash 140 positioned substantially over the pet's 100 spine.

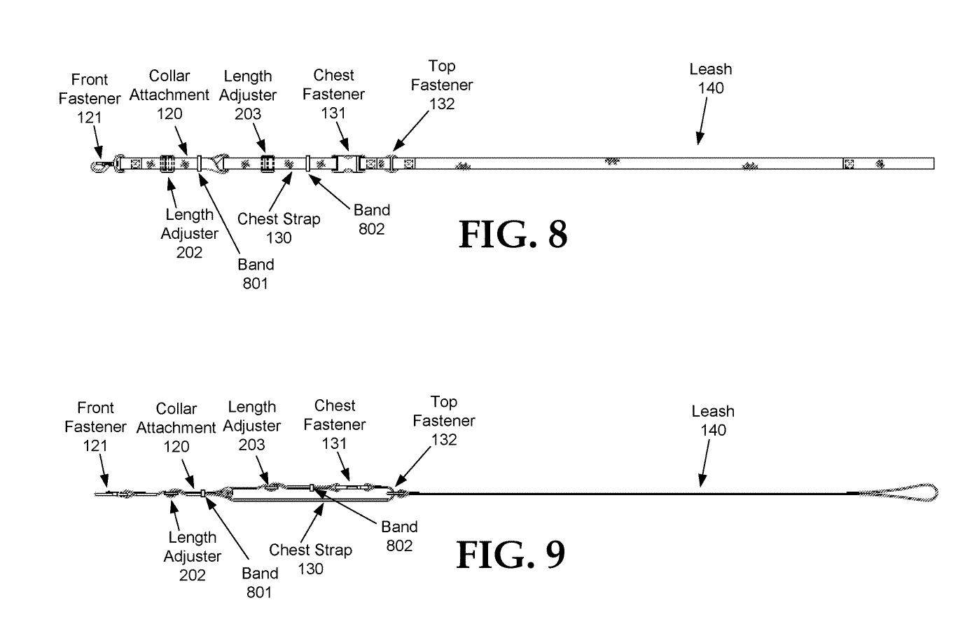

FIG. 8 and FIG. 9 illustrate a top and side view, respectively of an example pet restraint. The example pet restraint includes various elements previously described herein, and like elements are identified by like identifiers. The pet restraint includes a collar attachment 120, a front fastener 121, a length adjuster 202, a chest strap 130, a chest fastener 131, a top fastener 132, a length adjuster 203, and a leash 140. The pet restraint furthermore illustrates bands 801 and 802, the use of while is also described herein.

While various embodiments have been disclosed herein, other aspects and embodiments will be apparent to those skilled in art.

1. A pet restraint consisting of:
an adjustable length collar attachment strap including a length adjuster for length adjustment thereof;
a front fastener attached to the collar attachment strap and positioned at a forward end of the collar attachment strap, wherein the front fastener comprises a clasp that is releasably attachable to an underside of a pet collar;
an adjustable length chest strap attached to the collar attachment strap and positioned at a rearward end of the collar attachment strap;
a chest fastener attached to the chest strap, wherein the chest fastener comprises a buckle including a first buckle element attached at a first end of the chest strap and a second buckle element attached at a second end of the chest strap, and wherein the first and second buckle elements are adapted to releasably buckle together in order to releasably fasten the chest strap around the pet's chest, and wherein length of the chest strap is adjustable by adjusting buckle position at the first or second end of the chest strap;
a leash; and
a top fastener attached to the chest strap and to a forward end of the leash, wherein the top fastener is slidably attached to the chest strap so that the top fastener and forward end of the leash are positionable above the pet's spine.

2. The pet restraint of claim 1, wherein the top fastener is non-releasably attached to the chest strap and to the forward end of the leash.

3. The pet restraint of claim 1, wherein the top fastener comprises a rectangular loop of metal.

4. A pet restraint comprising:
a collar attachment;
a front fastener attached to the collar attachment and positioned at a forward end of the collar attachment, wherein the front fastener is releasably attachable to an underside of a pet collar;
a chest strap attached to the collar attachment and positioned at a rearward end of the collar attachment;
a chest fastener attached to the chest strap, wherein the chest fastener comprises a first fastener element attached at a first end of the chest strap and a second fastener element attached at a second end of the chest strap, and wherein the first and second fastener elements are adapted to releasably fasten together in order to releasably fasten the chest strap around the pet's chest;
a leash; and
a top fastener attached to the chest strap and to a forward end of the leash, wherein the top fastener and forward end of the leash are positionable above the pet's spine.

5. The pet restraint of claim 4, wherein the collar attachment includes a length adjuster for length adjustment thereof.

6. The pet restraint of claim 4, wherein the collar attachment includes a collar attachment strap.

7. The pet restraint of claim 4, wherein the front fastener comprises a clasp.

8. The pet restraint of claim 4, further comprising a rear fastener which attaches the chest strap to the collar attachment at the rearward end of the collar attachment.

9. The pet restraint of claim 4, wherein the chest fastener comprises a buckle.

10. The pet restraint of claim 4, wherein length of the chest strap is adjustable by adjusting fastener element position at the first or second end of the chest strap.

11. The pet restraint of claim 4, wherein the chest strap includes a length adjuster for length adjustment thereof.

12. The pet restraint of claim 4, wherein the top fastener is slidably attached to the chest strap.

13. The pet restraint of claim 4, wherein the forward end of the leash comprises a clasp which is releasably attached to the top fastener.

14. The pet restraint of claim 4, further comprising the pet collar which is releasably attachable to the front fastener.

15. The pet restraint of claim 4, wherein the pet collar is adjustable length and comprises a buckle collar fastener.

16. A pet restraint comprising:
three straps consisting of:
a collar attachment strap;
a chest strap attached to the collar attachment strap and positioned at a rearward end of the collar attachment strap; and
a leash; and
a plurality of fasteners, comprising:
a front fastener attached to the collar attachment and positioned at a forward end of the collar attachment, wherein the front fastener is releasably attachable to an underside of a pet collar;
a chest fastener attached to the chest strap, wherein the chest fastener comprises a first fastener element attached at a first end of the chest strap and a second fastener element attached at a second end of the chest strap, and wherein the first and second fastener elements are adapted to releasably fasten together in order to releasably fasten the chest strap around the pet's chest; and
a top fastener attached to the chest strap and to a forward end of the leash, wherein the top fastener and forward end of the leash are positionable above the pet's spine.
